(19) United States
(12) Patent Application Publication
(10) Pub. No.: US 2012/0307063 A1
(43) Pub. Date: Dec. 6, 2012

(54) MULTIFUNCTIONAL TRAFFIC INDICATING DEVICE

(75) Inventor: CHUN-AN LAI, Tu-Cheng (TW)

(73) Assignee: HON HAI PRECISION INDUSTRY CO., LTD., Tu-Cheng (TW)

(21) Appl. No.: 13/217,291

(22) Filed: Aug. 25, 2011

(30) Foreign Application Priority Data
Jun. 3, 2011 (TW) 100119716

(51) Int. Cl. H04N 7/18; G08G 1/07; G08G 1/095

(52) U.S. Cl. 348/149; 340/907; 340/925; 348/E07.085

(57) ABSTRACT

A traffic indicating device includes a support body, a traffic indicating assembly, an illuminating assembly, and a control module. The support body comprises a main portion and an arm portion perpendicular connected to an end of the main portion. The traffic indicating assembly is mounted to the support body. The illuminating assembly comprises a rod portion mounted to the end of the support body opposite to the arm portion and a light mounted on a distal end of the rod portion. The control module controls the traffic indicating assembly to indicate the traffic and controls the light to illuminating the road.

### BACKGROUND

1. Technical Field

The disclosure generally relates to traffic indicating devices, and particularly to a road functional traffic indicating device having an illuminating function.

2. Description of Related Art

To insure safe and continuously smooth traffic, a traffic light is mounted adjacent to an intersection to control competing flows of traffic. In addition, a streetlight is mounted beside a road for illuminating the road. However, the traffic light and the streetlight are commonly independently mounted beside the road, which may occupy much space beside the road and doesn't benefit city management and beautification when the traffic light and the streetlight are improperly arranged.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of a traffic indicating device, according to an exemplary embodiment.

FIG. 2 is similar to FIG. 1, but showing the traffic indicating device of FIG. 1 in another aspect.

FIG. 3 is a block diagram of the traffic indicating device of FIG. 1, according to an exemplary embodiment.

### DETAILED DESCRIPTION

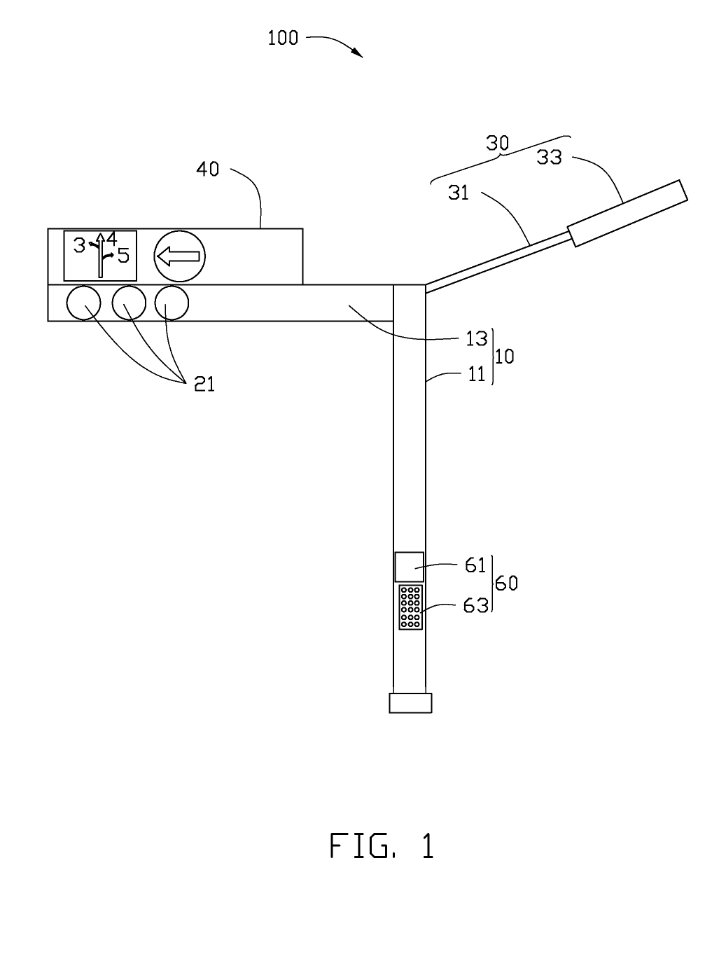

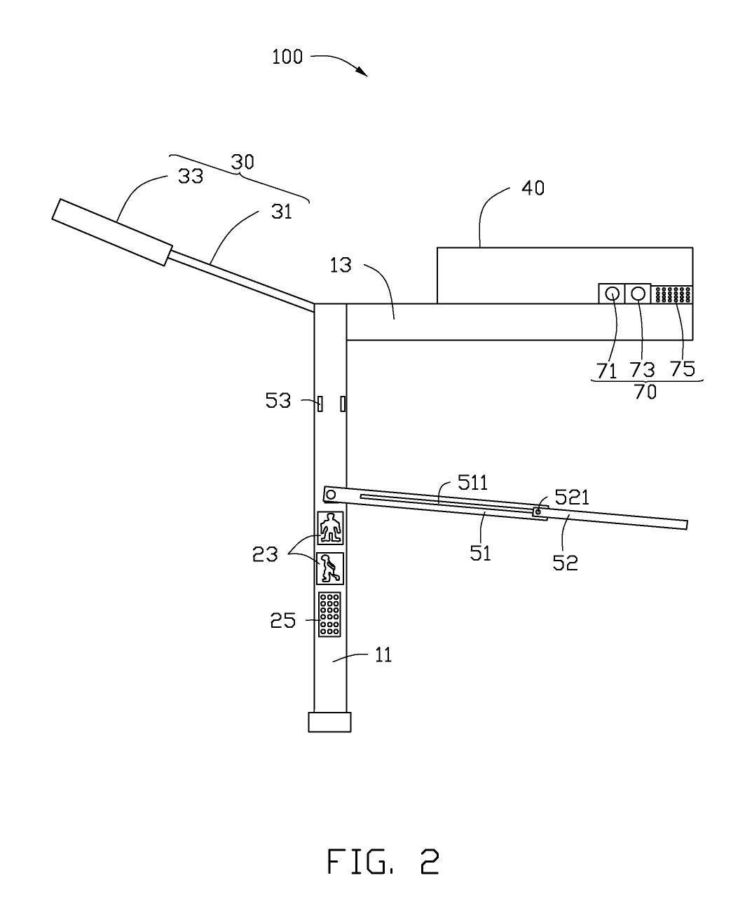

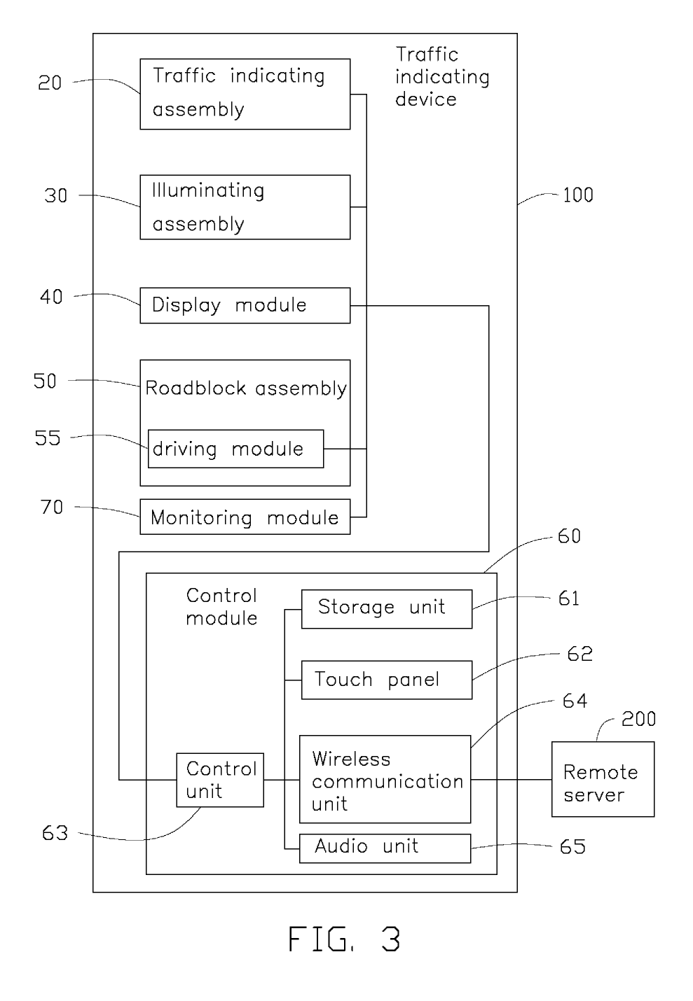

FIG. 1 is a schematic view of a traffic indicating device 100, according to an exemplary embodiment. Also referring to FIGS. 2 and 3, the traffic indicating device 100 includes a support body 10, a traffic indicating assembly 20, an illuminating assembly 30, a display module 40, a roadblock assembly 50, a control module 60 and a monitoring module 70.

The support body 10 includes a longitudinal main portion 11, and a horizontal arm portion 13 perpendicular connected to an end of the main portion 11. Another end of the main portion 11 opposite to the arm portion 13 can be installed on a road. The arm portion 13 is parallel to the road. The traffic indicator assembly 20, the illuminating assembly 30, the display module 40, the roadblock assembly 50, the control module 60, and the monitoring module 70 are assembled on the support body 10.

The traffic indicating assembly 20 includes a group of traffic lights 21, a group of pedestrian indicators 23, and an audio indicating module 25. The group of traffic lights 21 is arranged on one side of the arm portion 13 for controlling the traffic by using lights in standard colors (red-amber/yellow-green). The group of pedestrian indicators 23 and the audio module 25 are mounted on one side of the main portion 11. The group of pedestrian indicators 23 and the audio module 25 display image or audio signals to indicate to a pedestrian to either stop or go.

The illuminating module 30 includes a rod portion 31 and a light 33. One end of the rod portion 31 is mounted to the end of the main portion 11 opposite to the arm portion 13. The light 33 is mounted on another end of the rod portion 31 opposite to the arm portion 13, facing and illuminating the road. The control module 60 according to the environment light intensity can change an illuminating intensity of the lamp 33.

The display module 40 is mounted on the arm portion 13 and faces the road. The display module 40 displays traffic information for road users such as the name of current road station, the name of next road station, a distance to next road station, or current weather report. In this embodiment, the display module 40 includes at least two displays set at two opposite sides of the arm portion 13 to display traffic information for the road users from two directions. The traffic information can be pre-stored in the control module 60.

The roadblock assembly 50 includes a first bar 51, a second bar 52, a latching member 53, and a driving module 55. The first bar 51 is rotatably mounted on the main portion 11. A sliding groove 511 is defined in the first bar 51. A length of the second bar 52 is substantially the same as the length of the sliding groove 511. The second bar 52 includes a sliding portion 521 set at an end. The sliding portion 521 is slidably received in the sliding groove 511. When the sliding portion 521 is slid to one end of the sliding groove 511 adjacent to the main portion 11, the second bar 52 is received in the sliding groove 511. When the sliding portion 521 is slid to another end of the sliding groove 511, the second bar 52 is pushed out from the sliding groove 511 to lengthen the first bar 51. The latching member 53 includes a pair of opposite poles telescopically mounted on the main portion 11. The latching member 53 can protrude from the main portion 11 to fix the first bar 51, and retract back to the main portion 11 to release the first bar 51 and stop the vehicles. The driving module 55 drives the movement of the latching member 53 and the roadblock assembly 50.

The control module 60 may be a computer, which includes a storage unit 61, a touch panel 62, a control unit 63, a wireless communication unit 64, and an audio unit 65.

The storage unit 61 stores the traffic information for the display module 40 and also stores life information such as map information, housing rent information in current region. The touch panel 62 is used to display the life information. The road users can access the life information by operating the touch panel 62. The control unit 63 is connected to the traffic indicating assembly 20, the illumining assembly 30, the display module 40, the roadblock assembly 50 and controls the workings of the traffic indicating assembly 20, the illumining assembly 30, the display module 40 and the roadblock assembly 50. The wireless communication unit 64 communicates with a remote server 200. Thus, the control module 63 can be remotely monitored or be controlled by the remote server 200. The audio unit 65 may include a speaker and a microphone. The audio unit 65 communicates with related department for helping in an emergency situation such as a car accident.

The monitoring module 70 includes a road camera 71, a video camera 73, and an infrared light 75 (see FIG. 2). The road camera 71 captures images of vehicles, which exceed the speed limit of the road. The video camera 73 monitors the status of the road. The infrared light 75 improves a light intensity for the road camera 71 and the video camera 73. The captured images and videos are sent to the control unit 63 and are stored in the storage unit 61. The remote server 200 can obtain the captured images and videos from the control unit 63. When an emergency happens, the remote server 200 can remotely control the control unit 63 to drive the roadblock assembly 50, and stop the vehicles.

The traffic indicating device 100 having the traffic indicator assembly 20 and the illuminating assembly 30 integrated together benefits for city management and beautification of the city. In addition, the road users can conveniently read the traffic information from the display module 40 and obtain information from the control module 60.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A traffic indicating device for a road, comprising:
a support body comprising a main portion and an arm portion connected to an end of the main portion;
a traffic indicating assembly mounted to the support body;
an illuminating assembly, comprising:
a rod portion mounted to the end of the support body opposite to the arm portion; and
a light mounted on a distal end of the rod portion; and
a control module controlling the traffic indicating assembly to indicate traffic and controlling the light to illuminating the road.

2. The traffic indicating device of claim 1, further comprising a display module mounted to the arm portion to display traffic information.

3. The traffic indicating device of claim 2, wherein the display module comprises at least two displays set at two opposite sides of the arm portion.

4. The traffic indicating device of claim 1, further comprising a roadblock assembly rotatably mounted on the main portion, wherein the control module controls the roadblock assembly to stop vehicles in response to an emergency condition.

5. The traffic indicating device of claim 3, wherein the roadblock assembly includes a first bar and a second bar, the first bar is rotatably mounted on the main portion, the first bar defines a sliding groove, and the second bar includes a sliding portion slidably received in the sliding groove.

6. The traffic indicating device of claim 4, wherein the roadblock assembly further includes a latching member telescopically mounted on the main portion for fixing the first bar, the latching member protrudes from the main portion to fix the first bar, and retract back to the main portion to release the first bar and stop the vehicles.

7. The traffic indicating device of claim 6, wherein the roadblock assembly further includes a driving module connected to the control module, the control module controls the driving module to drive movements of the first bar and the latching member.

8. The traffic indicating device of claim 1, wherein the traffic indicating assembly includes a group of traffic lights arranged on one side of the arm portion, and a group of pedestrian indicators and an audio indicating module mounted on one side of the main portion.

9. The traffic indicating device of claim 2, wherein the control module includes a storage unit, a touch panel, and a control unit, the storage unit stores the traffic information for the display module and also stores life information, the touch panel is used to access the life information, the control unit controls works of the traffic indicating assembly, the illumining assembly, the display module and the roadblock assembly.

10. The traffic indicating device of claim 9, wherein the control module further includes a wireless communication unit communicating with a remote server, the control unit can be remotely monitored or controlled by the remote server via the wireless communication unit.

11. The traffic indicating device of claim 9, further comprising a monitoring assembly, wherein the monitoring assembly includes a road camera capturing images of vehicles which exceed the speed limit, a video camera monitoring the status of the road, and an infrared light improving a light intensity for the road camera and the video camera, the captured images and videos are sent to the control unit and stored in the storage unit.
